(19) United States
(12) Patent Application Publication
(10) Pub. No.: US 2025/0373411 A1
(43) Pub. Date: Dec. 4, 2025

(54) Protecting already signed documents and code using classical encryption algorithms against quantum attacks

(71) Applicant: DigiCert, Inc., Lehi, UT (US)

(72) Inventor: Avesta Hojjati, Austin, TX (US)

(73) Assignee: DigiCert, Inc., Lehi, UT (US)

(21) Appl. No.: 18/675,608

(22) Filed: May 28, 2024

(51) Int. Cl. H04L 9/06; H04L 9/32

(52) U.S. Cl. CPC H04L 9/0643; H04L 9/3236; H04L 9/3247

(57) ABSTRACT

Protecting already signed documents and code using classical encryption algorithms includes obtaining a signed document where the signed document has previously been signed using a classical encryption algorithm; determining a hash of the signed document; encrypting the hash of the signed document to obtain a digital signature, wherein the encrypting utilizes a private key associated with a Post-Quantum Cryptography (PQC) algorithm; and attaching the digital signature to the signed document to provide a PQC signed document which is protected against quantum attacks on the classical encryption algorithm. Verification includes receiving a document that purports to be the PQC signed document; decrypting the digital signature using a public key associated with the private key to obtain the hash; determining a second hash of the document that purports to be the PQC signed document; and comparing the hash and the second hash to determine validity.

### FIELD OF THE DISCLOSURE

The present disclosure relates generally to trust and encryption. More particularly, the present disclosure relates to systems and methods for protecting already signed documents and code using classical encryption algorithms against quantum attacks with Post-Quantum Cryptography (PQC) algorithms.

### BACKGROUND OF THE DISCLOSURE

Document signing is the process of adding a signature to a document to indicate approval, authorization, authenticity, and/or acknowledgment of its contents. Further, document signing can use digital signatures, namely using cryptographic techniques. Here, the vast majority of cryptographic techniques used to date include classical encryption algorithms. The purpose of document signing is authentication of the signer's identity, confirmation of the signer's intent such as agreement to a document's terms or contents, and evidence the document has not been altered since the signing. Document signing is used in various contexts, including contracts, legal agreements, financial transactions, and many other situations where formal approval is required. Also, as is described herein, the term documents can include other types of electronic content, such as software, etc. The number of documents digitally signed to date with classical encryption (public-key cryptography) is vast and continuously growing. One concern is the emerging threat of quantum computers and their impact on classical encryption algorithms. Such a threat has the potential to question the signature on every document signed to date. Of course, the time and effort required to re-sign every document signed to date with classical encryption algorithms is complex, time consuming, and practically impossible to cover every document. There needs to be a way to protect already signed documents with classical encryption algorithms with newer quantum resistant approaches, referred to generally as PQC algorithms.

### BRIEF SUMMARY OF THE DISCLOSURE

The present disclosure relates to systems and methods for protecting already signed documents and code using classical encryption algorithms against quantum attacks with Post Quantum Cryptography (PQC) algorithms. In particular, the approach described herein includes generating a hash of already signed documents (signed with classical encryption algorithms) and signing the has with PQC algorithms, with the objective of protecting already signed documents against quantum computing. Advantages of this approach include:
(1) There is no need to find the original signers of the document as those documents as of right now are in a good standing (signed by valid signers and algorithms) where right now means today, pre-quantum computers,
(2) Generating a hash of already signed documents will guarantee that the existing document will not be modified, and
(3) Signing the hash with PQC algorithms will guarantee that the hash will stay secure towards quantum attacks.

Thus, with the techniques described herein, the vast number of already signed documents can be protected against quantum computers. Of course, quantum computers will be able to break the classical encryption algorithms, but by having the hash of the already signed document protected with PQC algorithms, any such attempt is detectable, continuing the trust of already signed documents.

The present disclosure contemplates implementation as a method having steps, via a computing environment with one or more processors configured to implement the steps, and as a non-transitory computer-readable medium storing instructions that, when executed, cause one or more processors to implement the steps. The steps include obtaining a signed document where the signed document has previously been signed using a classical encryption algorithm; determining a hash of the signed document; encrypting the hash of the signed document to obtain a digital signature, wherein the encrypting utilizes a private key associated with a Post-Quantum Cryptography (PQC) algorithm; and attaching the digital signature to the signed document to provide a PQC signed document which is protected against quantum attacks on the classical encryption algorithm.

The present disclosure leverages the fact classical encryption algorithms have not yet been broken, so existing digital signatures can be trusted. The present disclosure further removes the need to re-sign documents by appending a PQC digital signature for the already signed document. This prevents an attacker from forging the already signed document since this will be detected based on a failure to match the digital signature of the PQC signed document.

### BRIEF DESCRIPTION OF THE DRAWINGS

The present disclosure is detailed through various drawings, where like components or steps are indicated by identical reference numbers for clarity and consistency.

FIG. 1 is a flow diagram of a document signing process.

FIG. 2 is a flow diagram of a document verification process.

FIG. 3 is a flow diagram of a document signing process using an already signed document and protecting it with a PQC algorithm.

FIG. 4 is a flowchart of a process for protecting already signed documents and code using classical encryption algorithms with a PQC algorithm.

FIG. 5 is a flow diagram of a document verification process for verifying the PQC signed document.

FIG. 6 is a block diagram of a computing environment, which may be one or more digital computers, virtual machines, servers, clusters, etc.

### DETAILED DESCRIPTION OF THE DISCLOSURE

Again, the present disclosure relates to systems and methods for protecting already signed documents and code using classical encryption algorithms against quantum attacks with Post Quantum Cryptography (PQC) algorithms. Advantageously, the present disclosure provides a solution to protect already signed documents from future quantum attacks which could allow an attacker to modify, forge, etc. an already signed document. The approach described herein can be performed without having to involve the original parties.

### Documents

As described herein, the term “document” is used to denote some digital content which can be in various formats, e.g., Portable Document Format (PDF), Windows Document (DOC or DOCX), Windows Executable (EXE), Dynamic Link Library (DLL), and the like. Also, the digital content can include legal documents (e.g., contracts, agreements, wills, power of attorney, etc.), financial documents (e.g., loan documents, tax forms, etc.), government documents (e.g., licenses, permits, etc.), or any type of document where there is a need to verity approval, authorization, authenticity, and/or acknowledgment of its contents. Further, the digital content can also include code or other software that is signed where it is important to verity source and that it has not been modified without approval. That is, as described herein, the term “document” refers to anything that is digitally signed today or has previously been digitally signed using classical encryption algorithms. Also, the term “document” could be used interchangeably with object, i.e., any file with content that can be digitally signed.

### Document Signing

Document or code signing is a cryptographic process used to ensure the approval, authorization, authenticity, and/or acknowledgment of a document or a piece of code. Again, the present disclosure is using the term document to represent a wide variety of digital content that has or is being digitally signed. This process replaced the traditional handwritten signature serving the same purpose, but providing a much higher level of security. A document is digitally signed by one or more parties (e.g., an individual, an organization, a government, etc.). This provides various benefits later in time.

First, the digital signature serves as assent or approval to the document akin to a handwritten, so-called wet ink signature. Here, an example includes a contract where the parties sign to effectuate the terms of the contract. Second, the digital signature indicates the one or more parties authorize the document, i.e., the contents of the document can be said to come from or be authorized by the signer. An example here includes a governmental document such as a license or registration and the digital signature means the signer authorized it. Third, the digital signature indicates the document is authentic, meaning it is the same document now compared to when it was signed. Examples here includes a contract where all of the parties can be assured there has been no modification of the document, code where someone looking to execute the code can be assured the code has not been modified such as maliciously, and the like. Finally, the digital signature can serve as an acknowledgement by a party, such as a sales agreement. Of course, digitally signing documents has become ubiquitous and another benefit includes an audit trail meaning there is much more evidence showing when a document was sent, reviewed, opened, and signed.

### Document Signing Process

Today and in the past, the document signing process using what is referred to herein as classical encryption algorithms. Some examples include:
(1) RSA (Rivest-Shamir-Adleman): Widely used for digital signatures and key exchanges. It is based on the mathematical difficulty of factoring large prime numbers.
(2) DSA (Digital Signature Algorithm): A Federal Information Processing Standard for digital signatures based on the mathematical concept of modular exponentiation and discrete logarithms.
(3) ECDSA (Elliptic Curve Digital Signature Algorithm): An elliptic curve variant of the DSA, offering similar levels of security with shorter key lengths, making it more efficient.

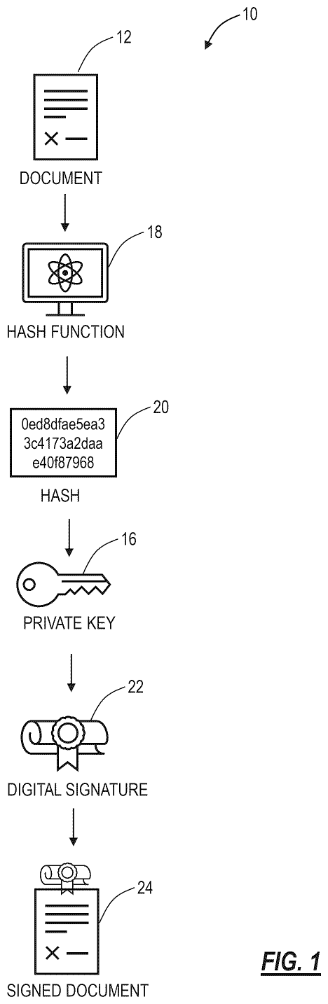

FIG. 1 is a flow diagram of a document signing process 10. The document signing process 10 is implemented in a computing environment that can include one or more processing devices, including one or more processors, cloud services, applications, and the like. The document signing process 10 can be implemented by a document signer which can be a service provider, Software-as-a-service (SaaS) provider, cloud provider, etc. The document signing process 10 includes a document 12 that is provided to the document signer. The document 12 is a file having contents and the objective of the document signing process 10 is to sign the contents. Again, the file can be a document, code, and the like.

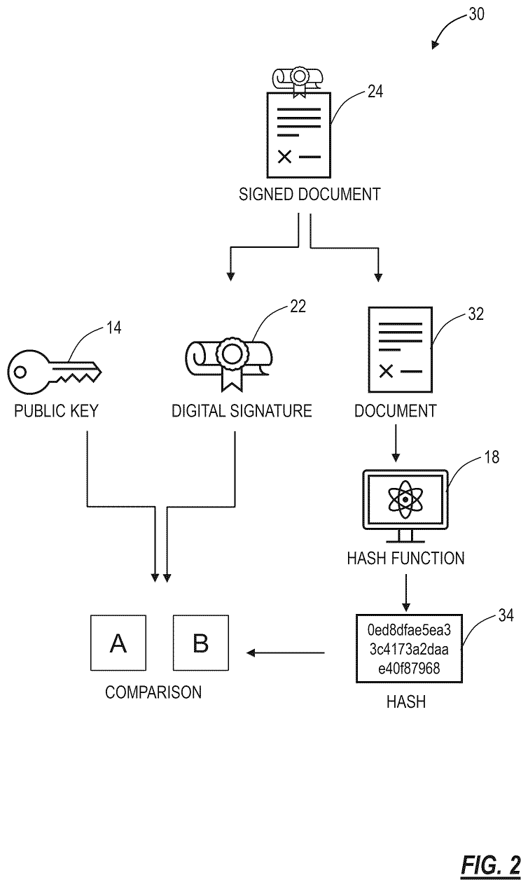

The document signing process 10 is described with reference to classical encryption algorithms, specifically public-key cryptography (also known as asymmetric encryption). That is, the vast majority of signed documents 12 currently and in the past have utilized classical encryption algorithms. Prior to the document signing process 10, the document signer generates a pair of cryptographic keys: a public key 14 (shown in FIG. 2) and a private key 16. The public key 14 can be shared with anyone, while the private key 16 is kept secret by the document signer. The public key 14 is a publicly available key used for encryption or signature verification. The private key 16 is a confidential key used for decryption or creating a digital signature.

The document signer receives the document 12, such as via a Web portal, an application, etc., uses a hash function 18 to create a hash 20 of the document 12. The hash function 18 is a mathematical algorithm that converts data into a fixed-size string of characters, which is typically a digest that uniquely represents the data. The data is included in the document 12. Of note, the hash 20 is a unique representation of data in the document 12. Any changes to the document 12 would yield a different hash 20. Some examples of hash functions 18 include:
(1) MD5 (Message Digest Algorithm 5): Output Size: 128-bit hash value. Characteristics: Widely used in the past but now considered cryptographically broken and unsuitable for further use due to vulnerabilities that allow for collision attacks.
(2) SHA-1 (Secure Hash Algorithm 1): Output Size: 160-bit hash value. Characteristics: More secure than MD5 but still considered insecure against well-funded attackers. Vulnerable to collision attacks.
(3) SHA-256 (Secure Hash Algorithm 256-bit): Output Size: 256-bit hash value. Characteristics: Part of the SHA-2 family, widely used and considered secure. Offers a good balance of security and performance.
(4) SHA-3 (Secure Hash Algorithm 3): Output Size: Variable (224, 256, 384, 512 bits). Characteristics: Designed as an alternative to SHA-2, based on a different cryptographic construction (Keccak). Offers robustness against different types of attacks.
(5) Blake2: Output Size: Variable (up to 512 bits). Characteristics: Designed for high performance and security. Faster than MD5, SHA-1, and SHA-2, and considered secure.
(6) Whirlpool: Output Size: 512-bit hash value. Characteristics: Designed to be secure and provide a large output size for high security.

The hash function 18 has the following properties:
(1) Deterministic: The same input always produces the same output.
(2) Fast Computation: The hash value should be quick to compute.
(3) Preimage Resistance: Given a hash value, it should be computationally infeasible to find the original input.
(4) Small Changes in Input Produce Large Changes in Output: A slight change in the input should produce a significantly different hash.
(5) Collision Resistance: It should be computationally infeasible to find two different inputs that produce the same hash value.
(7) Avalanche Effect: Every bit of the hash value should depend on every bit of the input data.

The document signer uses the private key 16 to encrypt the hash 20. This encrypted hash value is a digital signature 22 for the document 12. Because the private key 16 is only known to the document signer, the digital signature 22 can be used to verify that the document 12 has not been altered. Finally, the digital signature 22 is attached to the original document 12 which can now be considered a signed document 24. This can be performed in various ways, such as issuing a certificate that includes the public key 14 along with any other identifying information, e.g., the hash function 18 used.

FIG. 2 is a flow diagram of a document verification process 30. The document verification process 30 is used after the document signing process 10 to verify a received document 32. After the document signing process 10, there is the signed document 24. Often, at some later point, there is a need to verify the signed document 24, i.e., there is the received document 32 and the question is does this match the signed document 24. This is the objective of the document verification process 30. The document verification process 30 can be implemented by the document signer or any party, including the one or more parties associated with the document 12. As described herein, with reference to the document verification process 30, it is performed by a recipient, such as someone in possession of the input document 32, wondering if this is in fact the received document 24 or not.

The recipient extracts the digital signature 22 and the public key 14 from the signed document 24. The recipient runs the received document 24 through the same hash function 18 used by the document signer to generate a new hash 34 value. Also, the recipient decrypts the digital signature 22 using the signer's public key 14, obtaining the original hash 20 value that was generated by the document signer. The recipient compares the hash 20 value obtained from decrypting the signature with the hash 34 value they generated from the received document 32. If the two hash values match, it confirms that the document 12 has not been altered and that the signature is valid, verifying the identity of the signer.

For illustration purposes, here is a simple example. A document has content “Hello, World!.” The hash value using SHA-256 is
c0535e4be2b79ffd93291305436bf889314e4a3faec05ecffcbb7df31e54a6a6

The encrypted hash using the private key is “Digital Signature.”

A received document includes the contents “Hello, World!” and there is a desire to verify this is a signed document. The extracted signature is “Digital Signature” and it is decrypted using the public key as:
c0535e4be2b79ffd93291305436bf889314e4a3faec05ecffcbb7df31e54a6a6

Also, the hash value is computed on the received document:
c0535e4be2b79ffd93291305436bf889314e4a3faec05ecffcbb7df31e54a6a6

There is a comparison of these hash values with the match confirming integrity and authenticity.

### Quantum Computing and Threats to Classical Encryption Algorithms

Quantum computing poses significant threats to classical encryption algorithms due to its potential to solve certain mathematical problems much more efficiently than classical computers. Shor's algorithm is a quantum algorithm that can efficiently factor large integers and compute discrete logarithms. These two problems are the foundation of classical encryption algorithms. For example, RSA's security is based on the difficulty of factoring large composite numbers. Shor's algorithm can factor these numbers in polynomial time, effectively breaking RSA encryption. Elliptic Curve Cryptography (ECC) relies on the hardness of the discrete logarithm problem over elliptic curves. Shor's algorithm can solve this problem efficiently, compromising ECC.

Quantum computing is not widely available at present with current systems supporting 50 to a few hundred qubits, and not yet capable of performing error-free computations needed for breaking classical encryption algorithms. However, the pace of development continues strong and there will be sufficiently powerful quantum computers available in the near term capable of defeating classical encryption algorithms. As such, quantum computers have the potential to forge digitally signed documents by leveraging their ability to efficiently solve the mathematical problems that underlie many classical cryptographic algorithms. Here's how this can happen:

(1) Classical RSA Signature Verification: RSA digital signatures work by encrypting a hash of the document with the signer's private key. The recipient uses the signer's public key to decrypt the signature and compare it with the hash of the received document. Quantum Attack: Using Shor's algorithm, a quantum computer can factorize the large composite number that constitutes the RSA modulus (n=p*q) into its prime factors (p and q). Once these factors are known, the private key can be derived from the public key. With the private key, an attacker can sign any document, forging the signature as if it came from the legitimate signer.

(2) Elliptic Curve Digital Signatures (ECDSA): Classical ECDSA Signature Verification: ECDSA relies on the difficulty of the elliptic curve discrete logarithm problem. The signer creates a signature using their private key, and the verifier checks it using the public key. Quantum Attack: Shor's algorithm can solve the discrete logarithm problem for elliptic curves efficiently. This allows a quantum computer to derive the private key from the public key. With the private key, an attacker can generate valid signatures for any document, making it appear as though the document was signed by the legitimate owner of the key.

Once the private key is obtained, an attacker can sign any document, making it indistinguishable from a legitimately signed document. This can be used to forge legal contracts, financial transactions, or any document requiring a digital signature. The attacker can also alter an existing signed document and re-sign it using the stolen private key. The altered document would appear legitimate to anyone verifying the signature with the public key.

The term attacker is meant to denote someone who wishes to forge or modify an already signed document 24. The attacker needs access to the public key, which is available with the signed document 24. Next, using the attacker would factorize RSA Modulus (for RSA) or Solve Discrete Logarithm (for ECDSA). Using Shor's algorithm, the attacker runs a quantum computation to derive the private key from the public key. With the private key, the attacker can create valid signatures for any document, including forging the signed document 24, modifying the contents of the signed document 24, etc. The attacker can distribute these forged documents, and they will pass verification checks as though they were legitimately signed.

Of course, this poses a significant threat to all of the currently signed documents 24 using the classical encryption algorithms. Also, it simply is infeasible to re-sign the currently signed documents 24 using PQC algorithms. While this is possible in select cases, on important documents, etc., it is simply impractical, too costly, etc. to do across the board.

### Protecting Already Signed Documents

In various embodiments, the present disclosure includes techniques to protect already signed documents 24, such as signed using the document signing process 10 with PQC algorithms. A key observation is that, as of today, all signed documents 24 are valid, since there does not exist a sufficiently capable quantum computer to break RSA or ECC. That is, everyone can agree that all signatures today with classical encryption algorithms are valid. Any current signed document 24 can be attested relative to approval, authorization, authenticity, and/or acknowledgment of its contents. Of course, current document signing processes going forward can start with and rely on PQC algorithms from the start, i.e., use PQC algorithms in the document signing process 10. Here, the corresponding signed document 24 is not at risk of forgery due to quantum computers.

That said, the present disclosure focuses on so-called already signed documents, meaning the signed document 24 was signed with classical encryption algorithms such as RSA or ECC. The present disclosure starts with the already signed document 24 and adds a PQC algorithm to sign that. As a result, the present disclosure includes:
(1) No need to find the original signers (one or more parties) and have them re-sign. Since we can attest to the fact the signed document 24 is valid today (i.e., RSA and ECC have not yet been broken), we know the signed document 24 is in good standing.
(2) We generate a new hash of the already signed document 24 to ensure that it cannot be modified, forged, edited, etc.
(3) We sign the new hash of the already signed document 24 with a PQC algorithm which guarantees this new hash will stay secure towards the quantum attacks.

Now, if an attacker breaks the classical encryption algorithms, gets the private key, and maliciously changes the already signed document 24, this will be detected based on the new hash of the forged document not matching the new hash of the already signed document 24. The attacker cannot get around this due to the new hash of the already signed document 24 being signed using PQC algorithms.

This approach can advantageously be applied by a document signer to a vast amount of already signed documents 24, thereby attesting to their previous signature and protecting against quantum attacks.

### PQC Algorithms

PQC algorithms are designed to be secure against the capabilities of quantum computers, specifically the attacks described herein with reference to ECC and RSA. The following describes the document signing process 10 with PQC algorithms, along with examples of some prominent PQC algorithms used for digital signatures. Similar to the classical encryption algorithms, there is a key generation step albeit with PQC algorithms. A pair of keys is generated: a private key for signing and a public key for verification. These keys are generated using algorithms that are believed to be resistant to quantum attacks. Again, similar to the approach with classical encryption algorithms, the document to be signed is hashed using a cryptographic hash function to create a fixed-size hash value. This hash value represents the document's content in a condensed form. The hash value is encrypted (signed) with the signer's private key using a PQC digital signature algorithm. The result is the digital signature.

The recipient uses the signer's public key and the same PQC algorithm to decrypt the digital signature and retrieve the hash value. The recipient also hashes the received document independently. If the independently generated hash value matches the hash value obtained from decrypting the digital signature, the document is verified as authentic and unaltered.

Examples of PQC Digital Signature Algorithms include:
(1) Lattice-Based Cryptography such as (a) CRYSTALS-Dilithium which is based on the hardness of lattice problems and which offers strong security with efficient performance, and (b) Falcon which is also lattice-based, focusing on smaller signature sizes and efficient verification.
(2) Hash-Based Cryptography such as (a) SPHINCS+ which is a stateless hash-based signature scheme that provides strong security guarantees but has larger signature sizes compared to lattice-based methods, and (b) LMS (Leighton-Micali Signature) which utilizes hash trees and one-time signatures and is suitable for environments where signature size is less of a concern.
(3) Code-Based Cryptography such as Classic McEliece which is based on the hardness of decoding random linear codes.
(4) Multivariate Quadratic Equations such as Rainbow which uses the difficulty of solving systems of multivariate quadratic equations, and is known for small public keys and relatively efficient signing and verification.

Of course, those skilled in the art will appreciate other PQC algorithms exist and are contemplated herewith.

Here is an example with CRYSTALS-Dilithium
(1) The signer generates a private-public key pair using the CRYSTALS-CRYSTALS-Dilithium algorithm. The private key is kept secure, while the public key is distributed to recipients.
(2) The document is hashed using a secure hash function, such as SHA-3, resulting in a hash value H.
(3) The signer uses their private key to sign the hash value H with CRYSTALS-Dilithium, producing the digital signature S.
(4) The recipient receives the document and the signature S.
(5) The recipient hashes the document independently to get H′.
(6) The recipient uses the signer's public key to verify the signature S. The verification process decrypts S to obtain the original hash value H.
(7) The recipient compares H with H′. If they match, the signature is valid, confirming that the document is authentic and has not been altered.

### Signing Existing Signed Documents with PQC Algorithms

To protect already signed documents 24 with classical encryption algorithms, the present disclosure leverages two facts:
(1) RSA, ECC, and other classical encryption algorithms are still unbreakable today. Thus, any current digital signatures 22 are valid as of today.
(2) The hash 20 of the document 12 will not match a hash of the corresponding signed document 24. Thus, we can protect the corresponding signed document 24 by signing a hash of the corresponding signed document 24 with a PQC algorithm.

The hash of a document 12 and the hash of the same document with a digital signature will not match. When you hash a document, you use a cryptographic hash function (e.g., SHA-256) to produce a fixed-size hash value that uniquely represents the document's content. This hash value is a concise fingerprint of the document.

### Example: Hash(document)=H.

When a digital signature is applied, the document itself is not altered. Instead, the hash of the document is created and then encrypted with the signer's private key to produce the signature. The digital signature is typically appended to the document, or sent alongside it, but it does not modify the original document's content.

### Example: DigitalSignature(Hash(document))=Signature

Hash of the Original Document: This is a hash value H produced directly from the document's content.

### Example: Hash(document)

Hash of the Document with Digital Signature Attached: If you were to hash the entire package, which includes the document plus the appended digital signature, the resulting hash value would be different from the hash of the original document alone because the digital signature is additional data.

### Example: Hash(document+Signature)

Here is an example Scenario. The original document has Content: “This is a sample document.” Hash: H1=Hash(“This is a sample document.”). The document with a digital signature has Content: “This is a sample document.”+Signature.

Hash: H2=Hash(“This is a sample document.”+Signature). Here, H1 and H2 will not match because H2 includes the additional data from the digital signature.

The original document's hash (H1) represents only the document's content. The hash of the document plus digital signature (H2) represents the combined content of the document and its signature, thus altering the original hash.

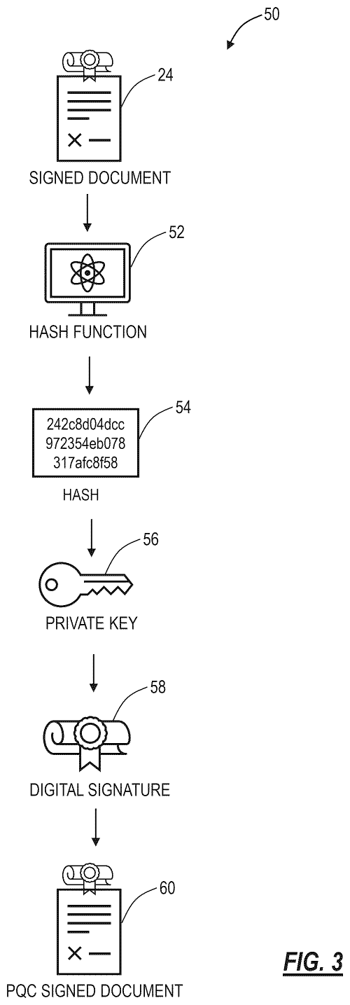

FIG. 3 is a flow diagram of a document signing process 50 using an already signed document 24 and protecting it with a PQC algorithm. Of note, the document signing process 50 generally follows the document signing process 10. However, the input is not the unsigned document 12, but the already signed document 24, i.e., the output of a previous document signing process 10. The already signed document 24 is input to a hash function 52 and this includes the document 10 along with the digital signature 22, to obtain a hash 54. Again, key to the hash 54 is that it is based on the already signed document 24 which includes the unsigned document 12 and the digital signature 22.

The hash 54 is then signed using a private key 56 from a PQC algorithm and this signed hash provides a digital signature 58. Similar to the digital signature 22, the digital signature 58 can be attached to the signed document 24 which can now be considered a PQC signed document 60. This can be performed in various ways, such as issuing a certificate that includes a public key 62 associated with the private key 56 along with any other identifying information, e.g., the hash function 52 used.

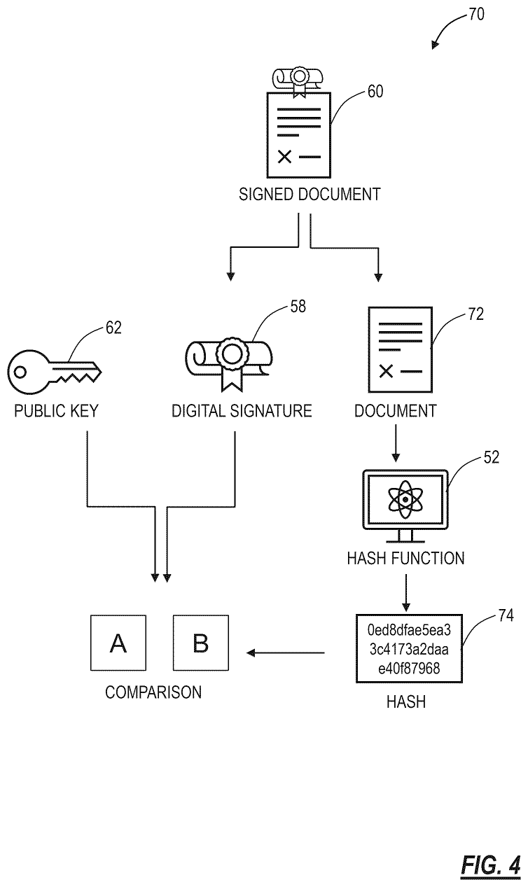

FIG. 4 is a flow diagram of a document verification process 70 for verifying the PQC signed document 60. Of note, the document verification process 70 generally follows the document verification process 30. However, the input here is the PQC signed document 60 and another document 72 that seeks to be verified.

Now, assume quantum computers have broken the classical encryption algorithm used to sign the already signed document 24. An attacker has generated the private key 16 from the public key 14 and done something to the contents of the already signed document 24. Using the document verification process 30, the forgery would not be detected. Now, in this example, the document 72 would be the forged version of the already signed document 24. The document 72 with the updated signature is hashed with the hash function 52 to provide a hash 74.

However, with the PQC signed document 60, the hash 74 will not match the hash 54 since there are changes to the document 72. Thus, a recipient would be able to detect this already signed document 24 is not valid.

### Process for Protecting Already Signed Documents

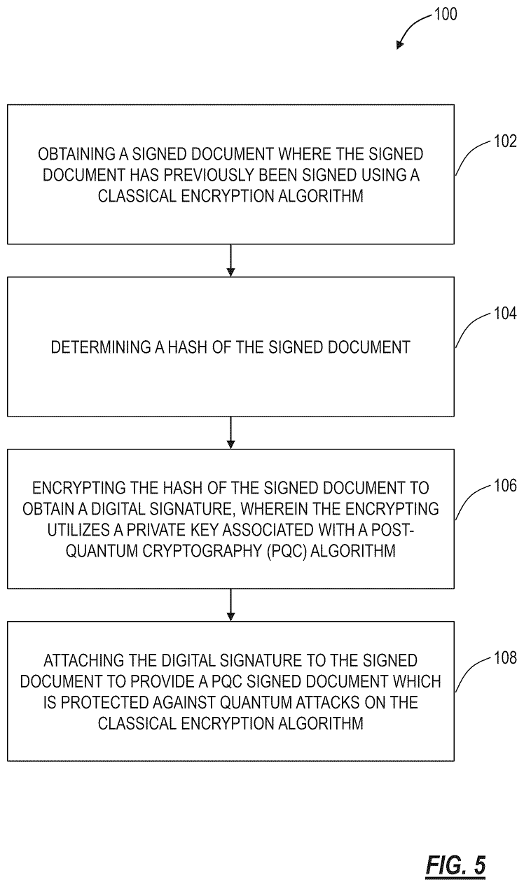

FIG. 5 is a flowchart of a process 100 for protecting already signed documents and code using classical encryption algorithms with a PQC algorithm. The process 100 contemplates implementation as a method having steps, via a computing environment with one or more processors configured to implement the steps, and as a non-transitory computer-readable medium storing instructions that, when executed, cause one or more processors to implement the steps. In an embodiment, the process 100 is implemented by a SaaS provider, a cloud provider, a software application, a document signer, etc.

The steps include obtaining a signed document where the signed document has previously been signed using a classical encryption algorithm (step 102); determining a hash of the signed document (step 104); encrypting the hash of the signed document to obtain a digital signature, wherein the encrypting utilizes a private key associated with a Post-Quantum Cryptography (PQC) algorithm (step 106); and attaching the digital signature to the signed document to provide a PQC signed document which is protected against quantum attacks on the classical encryption algorithm (step 108).

The steps can also include receiving a document that purports to be the PQC signed document; decrypting the digital signature using a public key associated with the private key to obtain the hash; determining a second hash of the document that purports to be the PQC signed document; and comparing the hash and the second hash to determine whether or not the document is the PQC signed document. The steps are performed prior to any quantum computer being able to successfully perform the quantum attacks on the classical encryption algorithm, thereby ensuring the signed document is valid.

The determining the hash of the signed document can include inputting the signed document and a digital signature from the classical encryption algorithm into a hash function. In an embodiment, the document is digital content. The e digital content can be one of a legal document, a financial document, and a government document. In another embodiment, the document is software code. The classical encryption algorithm can be one of Elliptic Curve Cryptography and Rivest-Shamir-Adleman. The PQC algorithm can utilize one of Lattice-Based Cryptography, Hash-Based Cryptography, Code-Based Cryptography, and Multivariate Quadratic Equations.

### Computing Environment

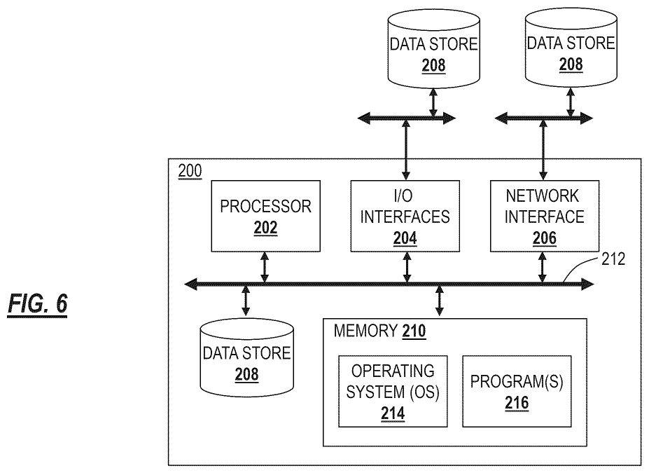

FIG. 6 is a block diagram of a computing environment 200, which may be one or more digital computers, virtual machines, servers, clusters, etc. The computing environment 200 generally includes one or more processors 202, input/output (I/O) interfaces 204, a network interface 206, a data store 208, and memory 210. It's important to note that FIG. 6 provides an oversimplified view of the computing environment 200, and a practical embodiment may include additional components and suitably configured processing logic to support conventional operating features not detailed here. The components (202, 204, 206, 208, and 210) communicate via a local interface 212, which include one or more buses or other wired or wireless connections known in the art. The local interface 212 may also include additional elements such as controllers, buffers (caches), drivers, repeaters, and receivers to facilitate communications. Furthermore, the local interface 212 includes address, control, and/or data connections to enable appropriate communications among the aforementioned components.

The processor 202 is a hardware device designed to execute software instructions. It can be a custom-made or commercially available processor, namely any device capable of executing software instructions. When the computing environment 200 is operational, the processor 202 executes software stored in the memory 210, communicates data to and from the memory 210, and generally controls the operations of the computing environment 200 based on the software instructions. The I/O interfaces 204 are used to receive user input from and provide system output to one or more devices or components. The network interface 206 enables the computing environment 200 to communicate on a network, such as the Internet 104. The network interface 206 includes address, control, and/or data connections to enable appropriate communications on the network.

The data store 208 is used to store data and includes volatile memory elements, nonvolatile memory elements, and combinations thereof. For instance, it may be an internal hard drive connected to the local interface 212 within the computing environment 200. Alternatively, the data store 208 could be an external hard drive connected to the I/O interfaces 204 (e.g., via SCSI or USB connection) or a network-attached file server. The memory 210 includes volatile memory elements, nonvolatile memory elements, and combinations thereof. The data store 208 and memory 210 incorporate electronic, magnetic, optical, and/or other types of storage media. The memory 210 may have a distributed architecture, with components situated remotely but accessible by the processor 202. The software in memory 210 includes one or more programs, each containing an ordered list of executable instructions for implementing logical functions. The memory 210 includes a suitable Operating System (O/S) 214 and one or more programs 216. The operating system 214 controls the execution of other computer programs, such as the one or more programs 216, and provides scheduling, input-output control, file and data management, memory management, communication control, and related services. The one or more programs 216 may implement the various processes, algorithms, methods, techniques, etc., described herein.

In some embodiments, the computing environment is a cloud system. Cloud computing systems and methods abstract away physical servers, storage, and networking, offering these as on-demand and elastic resources. The National Institute of Standards and Technology (NIST) defines cloud computing as a model for enabling convenient, on-demand network access to a shared pool of configurable computing resources (e.g., networks, servers, storage, applications, and services) that can be rapidly provisioned and released with minimal management effort or service provider interaction. The phrase “Software as a Service” (SaaS) is often used to describe application programs offered through cloud computing. The term “the cloud” is commonly used as shorthand for a provided cloud computing service or an aggregation of all existing cloud services.

### Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
obtaining a signed document where the signed document has previously been signed using a classical encryption algorithm;
determining a hash of the signed document;
encrypting the hash of the signed document to obtain a digital signature, wherein the encrypting utilizes a private key associated with a Post-Quantum Cryptography (PQC) algorithm; and
attaching the digital signature to the signed document to provide a PQC signed document which is protected against quantum attacks on the classical encryption algorithm.

2. The method of claim 1, wherein the steps further include:
receiving a document that purports to be the PQC signed document;
decrypting the digital signature using a public key associated with the private key to obtain the hash;
determining a second hash of the document that purports to be the PQC signed document; and
comparing the hash and the second hash to determine whether or not the document is the PQC signed document.

3. The method of claim 1, wherein the steps are performed prior to any quantum computer being able to successfully perform the quantum attacks on the classical encryption algorithm, thereby ensuring the signed document is valid.

4. The method of claim 1, wherein the determining the hash of the signed document includes inputting the signed document and a digital signature from the classical encryption algorithm into a hash function.

5. The method of claim 1, wherein the document is digital content.

6. The method of claim 5, wherein the digital content is one of a legal document, a financial document, and a government document.

7. The method of claim 1, wherein the document is software code.

8. The method of claim 1, wherein the classical encryption algorithm is one of Elliptic Curve Cryptography and Rivest-Shamir-Adleman.

9. The method of claim 1, wherein the PQC algorithm utilizes one of Lattice-Based Cryptography, Hash-Based Cryptography, Code-Based Cryptography, and Multivariate Quadratic Equations.

10. A computing environment comprising one or more processors and memory storing instructions that, when executed, cause the one or more processors to:
obtain a signed document where the signed document has previously been signed using a classical encryption algorithm;
determine a hash of the signed document;
encrypt the hash of the signed document to obtain a digital signature, wherein the hash is encrypted using a private key associated with a Post-Quantum Cryptography (PQC) algorithm; and
attach the digital signature to the signed document to provide a PQC signed document which is protected against quantum attacks on the classical encryption algorithm.

11. The computing environment of claim 10, wherein the instructions that, when executed, further cause the one or more processors to:
receive a document that purports to be the PQC signed document;
decrypt the digital signature using a public key associated with the private key to obtain the hash;
determine a second hash of the document that purports to be the PQC signed document; and
compare the hash and the second hash to determine whether or not the document is the PQC signed document.

12. The computing environment of claim 10, wherein the PQC signed document is determined prior to any quantum computer being able to successfully perform the quantum attacks on the classical encryption algorithm, thereby ensuring the signed document is valid.

13. The computing environment of claim 10, wherein the hash of the signed document is determined by inputting the signed document and a digital signature from the classical encryption algorithm into a hash function.

14. The computing environment of claim 10, wherein the document is digital content.

15. The computing environment of claim 14, wherein the digital content is one of a legal document, a financial document, and a government document.

16. The computing environment of claim 10, wherein the document is software code.

17. The computing environment of claim 10, wherein the classical encryption algorithm is one of Elliptic Curve Cryptography and Rivest-Shamir-Adleman.

18. The computing environment of claim 10, wherein the PQC algorithm utilizes one of Lattice-Based Cryptography, Hash-Based Cryptography, Code-Based Cryptography, and Multivariate Quadratic Equations.

19. A non-transitory computer-readable medium comprising instructions that, when executed, cause one or more processors to implement steps of:
obtaining a signed document where the signed document has previously been signed using a classical encryption algorithm;
determining a hash of the signed document;
encrypting the hash of the signed document to obtain a digital signature, wherein the encrypting utilizes a private key associated with a Post-Quantum Cryptography (PQC) algorithm; and
attaching the digital signature to the signed document to provide a PQC signed document which is protected against quantum attacks on the classical encryption algorithm.

20. The non-transitory computer-readable medium of claim 19, wherein the steps further include:
receiving a document that purports to be the PQC signed document;
decrypting the digital signature using a public key associated with the private key to obtain the hash;
determining a second hash of the document that purports to be the PQC signed document; and
comparing the hash and the second hash to determine whether or not the document is the PQC signed document.
